(19) United States
(12) Patent Application Publication
(10) Pub. No.: US 2008/0320418 A1
(43) Pub. Date: Dec. 25, 2008

(54) Graphical User Friendly Interface Keypad System For CAD

(75) Inventors: Chao-Ping Huang, Sunnyvale, CA (US); Sheng-Chun Yuan, Taipei (TW)

Correspondence Address: PERKINS COIE LLP, P.O. BOX 1208, SEATTLE, WA, 98111-1208, US

(73) Assignee: CADexterity, Inc., Cupertino, CA (US)

(21) Appl. No.: 11/766,350

(22) Filed: Jun. 21, 2007

(51) Int. Cl. G06F 3/048

(52) U.S. Cl. 715/840

(57) ABSTRACT

The present invention offers an improved GUI interface for CAD software to allow users easy access to menus. A user can execute commands and options with little disruption and with minimal hand movement. The keypad is represented on the computer screen and is called a GUFI (Graphical User Friendly Interface) keypad system. The keypad is a menu having a matrix of graphical buttons. A user selects a computer resource with a spatial input device and clicks the proper context button, the GUFI keypad displays only the functions or commands that pertain to the computer resource selected. The unique GUFI keypad system displays functions and commands in an arrayed, not in a pop-up or pull down menu, but in a pattern relating to the keys on the keyboard. Menu items are accessed through a one to one correspondence with the represented keys mapped to similar physically represented keys.

### BACKGROUND OF THE INVENTION

1. Field of the Invention

The present invention relates to a computer assisted design (CAD) system. In particular, the present invention relates to an improved GUFI (Graphical User Friendly Interface) interface for CAD software to allow users easy access to menus.

2. Description of the Related Art

Traditionally, computer assisted design (CAD) relied on pull down and pop up menus to execute functions. In CAD, functions must be executed about 10 to 30 times a minute. Traditionally, a user has to (1) leave the environment, (2) look for a popup or pull-down menu, (3) open the appropriate menu, and (4) execute the command by cricking on the appropriate selection on the menu. In the age of fast computer processor, it is no longer the chip speed that limits design speed, but rather the speed at which a user can execute commands.

The heavy reliance on the mouse to execute functions also slows down the design process. The mouse was not designed to execute functions. Making the user use the mouse to execute functions is not an optimal use of the user's hands. To illustrate this point, suppose that a typist were required to type a letter by selecting letters from a pull-down menu using only a mouse. Such a user would type about 6-10 words a minute. If one were to run an office using only pull-down menus to type letters, it would be inefficient. Labor costs would increase by at least ten times. The system would also be cumbersome and less reliable.

Many inventions have tried to improve the GUI (Graphical User Interface). Retter in U.S. Pat. No. 5,825,362 attempts to eliminate the necessity of using a mouse through a hierarchy of functions within keyboard accessible menus. Unfortunately, if spatial manipulation of objects on the screen is essential for the task at hand, the keyboard is inefficient compared to input devices such as a mouse. Also, it is inconvenient to use two input devices where only one need be used. Retter in U.S. Pat. No. 5,664,133 describing a context sensitive pop-up menu, reduces the difficulty in reaching the initial pull-down menus and offers the benefit of limiting the commands to those most applicable. Unfortunately, upon implementations of this invention, we once again find nested and pop-up menus. These require users to hunt for particular commands.

### Introduction and Philosophy of the UFO CAD System of the Prior Art

The UFO Design System is quoted in the UFO Beta Guide as follow:

### User Interface:

UFO employs a Graphical User Interface GUI. In a conventional GUI system, all commands are arranged in fixed menus and it is the user's responsibility to navigate through the menus to find the desired command. This mechanism requires repetitive mouse movement to those fixed menu locations and extensive search at times through the menu hierarchy in order to invoke the appropriate command. This is not only time-consuming, but also serves to constantly interrupt the user's logical thought process. The fallacy is that GUI system requires the user to stop whatever he or she is doing, leave the post and go “somewhere else” to look for the necessary tool in order to continue the work. This inherent inefficiency is primary reason why CAD today has turned into Computer Against Design. To alleviate this problem, the pop-up menu and key binding system was developed, and have been widely used in the industry. The pop-up menu GUI system helped by moving the menu closer to the user, but it still imposes constant interruption to the user. The key-binding system traded the “user friendliness” of the GUI with the old command line driven interface, which in turn put the back to memorizing commands and associating them to the meaningless “CTRL-P”, “SHIFT-O” types of key sequences.

### OBJECTS OF THE INVENTION

It is therefore an object of the invention to provide a Graphical User Friendly Interface (GUFI) keypad system for a CAD computer program to allow users easily access to menus such that a user can execute commands and options with little disruption and with minimal hand movement.

It is another object of the invention to provide a GUFI keypad system allows greater user power. A user can manipulate an object on the screen by context clicking on the resource with the user's spatial input device.

### DISCLOSURE OF THE INVENTION

A first aspect of the present invention teaches a Graphical User Friendly Interface (GUFI) keypad system for a CAD computer program, includes a menu in a CAD program, display in a computer screen; a matrix held inside the menu, said matrix also displayed on said computer screen; a plurality of buttons arranged in said matrix, forming a button matrix displayed on said computer screen; a plurality of keyboard keys mapped to said plurality of buttons, whereby allowing a user to press one or more keyboard keys, whereby said pressed keyboard key presses its corresponding button activates corresponding CAD functions.

The GUFI keypad system further includes a refreshing means to contextually update the button matrix to a new context sensitive user definable button matrix; a means for a user to manually navigate among a plurality of button matrices, this means includes pressing a button on a keyboard to cycle through contextually available button matrices; a pointing device such as a mouse or trackball that allows the user to configure the buttons on the button matrix whereby button can be added, moved or deleted.

The keyboard keys are mapped to a plurality of buttons according to a three by five matrix which is three high and five wide. The three by five matrix consists of (1) keys Q W E R T mapped to a top row of the three by five matrix; (2) keys A S D F G mapped to a middle row of the three by five matrix; (3) keys Z X CV B mapped to a bottom row of the three by five matrix; (4) keys Y U I O P mapped to a top row of the three by five matrix; (5) keys H J K L mapped to a middle row of the three by five matrix; and (6) keys N M , . / mapped to a bottom row of the three by five matrix. The three by five matrix is configured to further display functionality of a button, when a user clicks on said button while pressing a predefined key.

### BRIEF DESCRIPTION OF THE DRAWINGS

The foregoing and other advantages of the invention will be more fully understood with reference to the description of the best embodiment and the drawing wherein:

FIG. 1 is a diagram of a GUFI Keypad Manu;

FIG. 2 is a diagram of a Key Map Menu;

FIG. 3 is a diagram of an Enabled Extended Menu;

FIG. 4 is a diagram of an Extended Menu;

FIG. 5 is a diagram of a File Menu;

FIG. 6 is a diagram of the Main Menu;

FIG. 7 is a diagram of an Object Sensitive Keypad;

FIG. 8 is a diagram of Mouse Functions and double click selection expansion;

FIG. 9 is a summary of Mouse Button Function;

FIG. 10 is a diagram of the depth mode button;

FIG. 11 is a Chart of the viewing modes capable in the UFO Design and Layout System;

FIG. 12 is a diagram of the selection of viewing mode from the toolbar or the keypad;

FIG. 13 is a diagram of using Selection Filters to overcome object congestion;

FIG. 14 is a flowchart of CAD design flow;

FIG. 15 is a diagram of the generation of layout from the keypad Lay/Sch command.

### DESCRIPTION OF THE PREFERRED EMBODIMENTS

### User Interface

The CAD system of the present invention is fundamentally and philosophically different from the computer's CAD systems that uses in the prior art. The improved CAD system is design around how a human naturally and intuitively draws and perceives space. A major part of an inventor's contribution often lies in his determination of the nature of the problem that was previously unappreciated by others in the art. (See Eibel Process Co. V Minnesota & Ontario Paper Co., 261 US 45, (1923))

When a young child first learns to draw with paper and crayons, the child uses his/her hands to move the paper and position it. The child also holds the crayon and positions it in three dimensional spaces. When the child draws, the crayon creates art in two dimensions. Thus, the child is cognitively traveling into a two dimensional world from a three dimensional world that he/she is accustomed to living in everyday. The interface between the two and three dimensional world including visual detection, hand, eye and brain coordination throughout the rest of his/her life, is learned and becomes the knowledge that a person uses in handwriting, drawing and painting. This learned behavior is the fundamental basis for intuitive graphical interface.

Most people have a dexterous hand and a clumsy hand. A right handed person can use his/her right hand better because it is being controlled primarily by the left brain. Thus, the first revolutionary advancement in the present invention is to allow all spatial motion to be controlled by one hand while using the other hand for executing commands. In this way, the improved CAD system can use the right brain, which is strong in language for executing all the functions and commands while use the left brain which is strong in spatial reasoning to manipulate space.

By organizing the commands into spatial commands and functional commands, the system is easier to learn. The user can easily remember that the mouse hand does all the motion while the keyboard does all the functions.

### 1. Details Of The Preferred Embodiment

### Manu System

The current graphical user interface has pull down menus and buttons to click that execute commands. Manus can be long. Their contents can be difficult and time consuming to fine. The one handed menu system allows execution of 99% of the commands without a mouse or combination keys.

When doing layout design, typing is not a common use of the keyboard. The extra functionality of the keyboard can be used to type functions, while the mouse is reserved for motion.

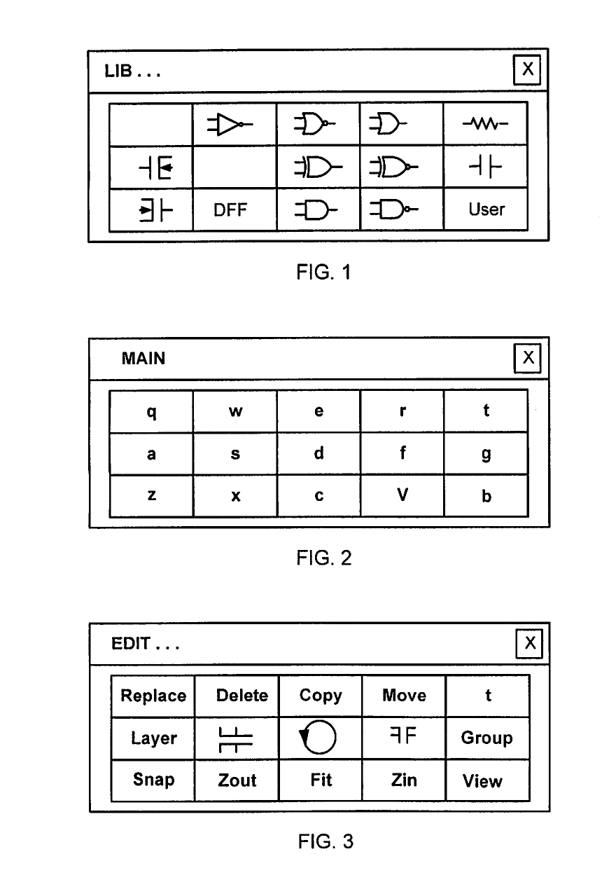

GUFI KEYPAD: The GUFI keypad shown in FIG. 1 shows the command or functions executable from the keypad. The GUFI keypad is made of a menu which contains a matrix. Buttons are arranged in the matrix so that they correspond to physical keyboard keys. The GUFI keypad can be described as an array of buttons, a matrix of buttons or simply a button matrix.

The GUFI keypad holds the commands otherwise placed in pull down or pop up menus. The best mode is to arrange the buttons on 3×5 grid. Thus, each keypad menu usually contains up to 15 commands. Each command can be invoked by a corresponding keyboard key. The menu on the screen is a visual representation of the pattern of keys on the keyboard. Thus, the keyboard key is said to be mapped to the command. The diagram in FIG. 2 shows the key mapping. Pressing the key corresponding to the command will execute that command.

On a standard “QWERTY” keyboard, the best mode is to map the fifteen buttons to the fifteen keys on the left handed side of the keyboard. Thus, the top row would be QWERT. The second row of the matrix would be ASDFG, and the third row of the matrix would be ZXCVB.

When a menu is called up, the menu grid refreshes so that the previous disappear and are replaced by the options listed under the chosen menu. This way a single graphic or button can be recycled for use in a different context. The user can also use the mouse to call up relevant keypad menus.

With the proper keypads programmed to anticipate the user's needs, the interface become more efficient. The user can even customize the GUFI keypads by dragging and dropping a button to another location on the keypad. The user could also use standard cut and past commands to customize the keypad layout. For example, if a user wanted to execute the resistor command in FIG. 1 with keyboard ‘r’, then the user could drag the resistor symbol and prop it on the button mapped to the button ‘r’. The resistor command would switch places with the command it replaces.

Activation of a command key can be case sensitive, requiring lower-case characters. This would reserve the shift button for other functions. The best mode is to allow the “Shift +<keypad command key>”, to give a one-line description for a specific Keypad command. The contextual help/information can also be displayed by simply pointing the mouse cursor to a key in the keypad. The keypad can be hidden or minimized to allow for more desktop drawing space.

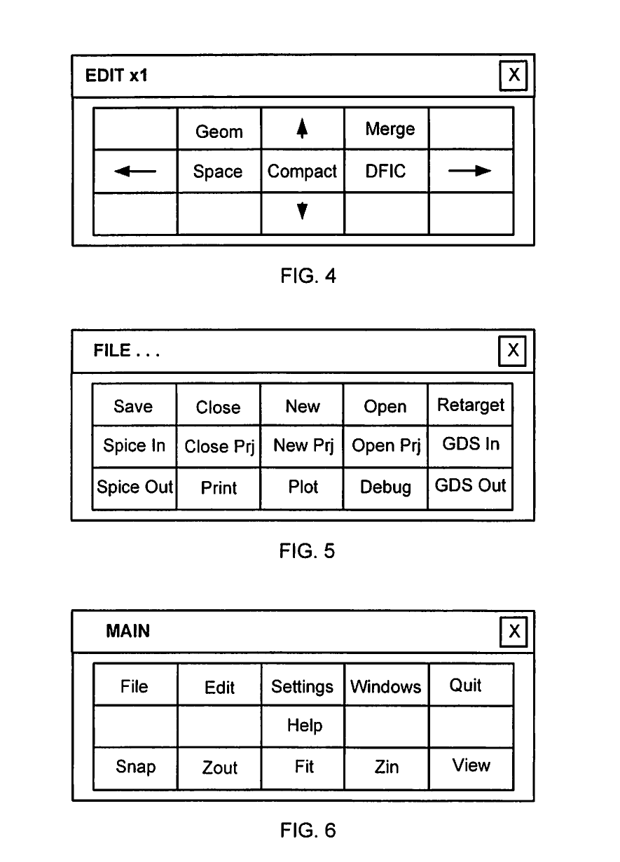

FIG. 3 shows an Enabled Extended Menu. The Keypad Menu can have Extended Menus if there are additional commands associated with the menu grouping. If there is an extended menu associated with a keypad menu, the menu title will be appended with a three dotted ellipsis. An example of the ellipsis is shown in FIG. 5 and FIG. 3. Extended Menu can be invoked by pressing the space bar on the keyboard. Extended menus have “x N” appended to the menu title, as shown in FIG. 4. Repeatedly press the space bar cycles through all extended keypad menus.

Keypad navigation is made easier by allowing a user to navigate with mouse buttons. A user can return to a higher level keypad in the keypad hierarchy by pressing the right mouse button. For example, the user can exit the File keypad menu, shown in FIG. 3, by pressing the right mouse button, which returns him to the Main keypad menu, as shown in FIG. 6.

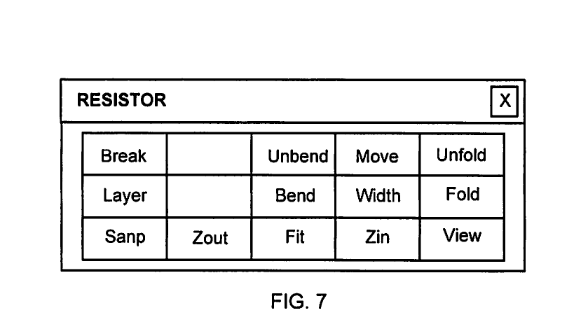

OBJECT SENSITIVITY saves time by automatically presenting only those options that a user is faced with in any particular context. The GUFI keypad is object-sensitive. A specific object-sensitive Keypad can be activated based on the currently selected object. The commands that are visible on the Object-sensitive Keypad are specific to the currently selected object. The Resistor Keypad is an example of this kind of keypad as shown in FIG. 7. The Resistor Keypad is activated if an object is selected.

### 2. Details Of The Preferred Embodiment:

### Mouse Function

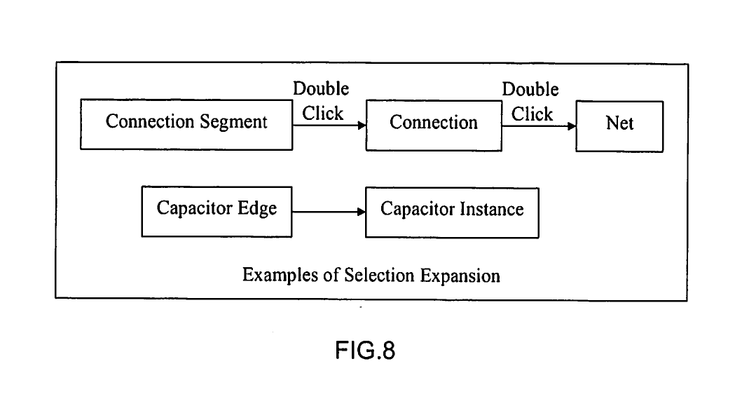

The motion system is all put in one hand. This one handed approach is preferred because traditionally, an artist holds a brush with one hand. In the computer context, a mouse is ordinarily used to control the position of the brush, which is usually the mouse cursor. FIG. 8 shows mouse functions selectable from among different parts of a drawing. Selection of a capacitor edge is achieved by clicking on the capacitor edge. To select the capacitor, for instance, a double click is used. This cycling of selection allows the user to select various objects or different parts of one object by repeatedly clicking on the object. A double click of the left mouse button expands a selection to the next higher-level design entity related to the current selected object.

It is obvious that a mouse is equivalent to other computer pointing devices such as trackballs, track-pads, joysticks, etc. Thus, the terminology ‘mouse’ as used by the inventor includes all pointing devices.

Single Click Mode:

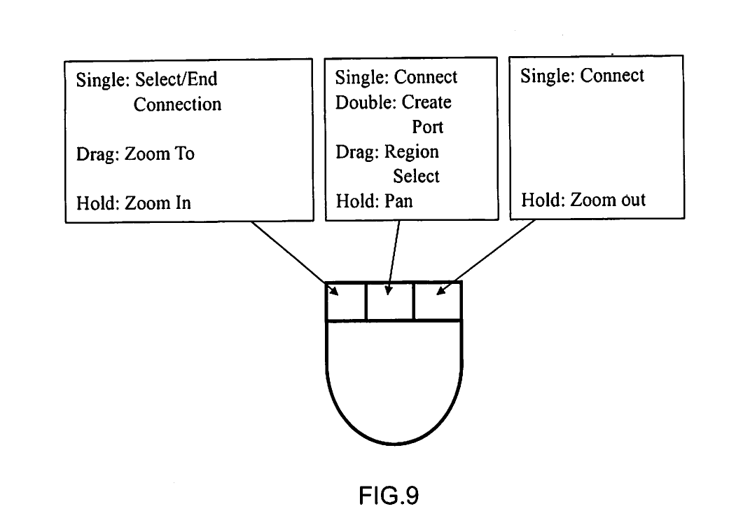

The particular of the mouse functions show the convenience of the GUFI system. In SINGLE CLICK MODE, the Left Mouse Button allows a user to Select and Deselect an object. FIG. 9 shoes a summary of mouse button functions. By moving the cursor to or near an unselected object and clicking the left mouse button once, the object will be selected and high-light. To select a second object, simply move the cursor over to the second object and left click on it. The object will be selected and high lighted while the first object remains selected. For an object that has already been selected, left mouse button clicking will deselect it.

When selecting in a congested area, it often happens that the first selection was not correct. In this case one can keep the mouse stationary and click the left mouse button one more time, the first incorrectly selected object will be deselected and the next nearest object will be elected and high-lighted. The Iterative Selection mechanism greatly simplifies selections in congested areas. The left mouse button click is also be used to terminate a connection at the connection end point as discussed below.

The Middle Mouse Button allows a user to Draw. The user can start a connection or create a vertex in a connection by clicking the middle mouse button. To end the connection, the user can left click on the termination point.

Right Mouse Button allows an Escape from the recently executed function. A single click on the right mouse button serves as an escape from the previous mouse action. Thus the mouse right-click acts like an Undo operation. For example, when a number of objects have been selected and the right mouse button is clicked once, all the selected objects will be deselected. Also, when digitizing a connection that currently has 6vertices, a right-click will back up to the 5^{Th} vertex.

Drag Mode:

In DRAG MODE, the Left Mouse Button can be used to Zoom to an object or area on the desktop. A user can Zoom To a particular region by holding down the left mouse button and then dragging the mouse cursor to form a rectangle around the desired zoom region.

The Middle Mouse Button allows a user to Region Select. A user can quickly select multiple objects by holding down the middle mouse button and by dragging the mouse cursor to form a rectangular region. All objects that are completely enclosed by region will be selected.

Hold Mode:

In HOLD MODE, the Left Mouse Button Zooms In. By holding down the left mouse button, a user can perform a continuous Zoom In operation to the location of the mouse cursor. The Middle Mouse Button Pans. By holding down on the middle mouse button, a user can perform continuous Pan operation relative to the center of the window. The Right Mouse Button Zooms Out. By holding down on the right mouse button, a use can perform a continuous Zoom Out operation.

The Mouse Button functions are summarized in FIG. 9. The GUFI system allows a user to single handedly maneuver the user's view of the work piece. The user can zoom in, zoom out and pan, all with one hand. This allows the user to interact with the virtual environment in a more comfortable and intuitive manner.

### 3. Details Of The Preferred Embodiment

### Viewing Mode

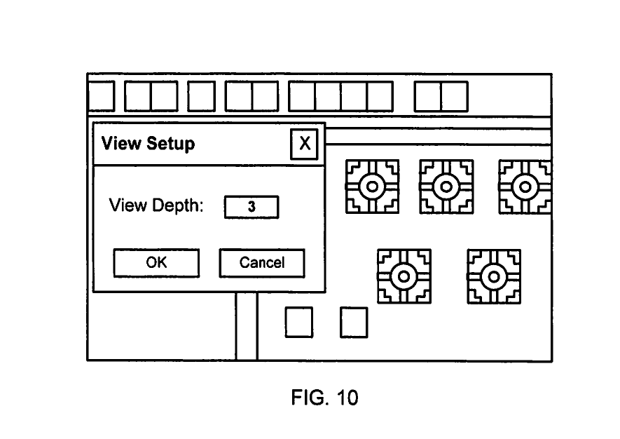

Some functions can also be activated with traditional GUI methods. In FIG. 10, clicking on a button bring up a menu to change the view depth. The View Depth controls how many levels of hierarchy are visible from the currently opened design. The Viewing Depth can be set from the application tool bar. Here, a user can use the mouse to activate buttons by clicking them on the keypad.

Viewing Modes:

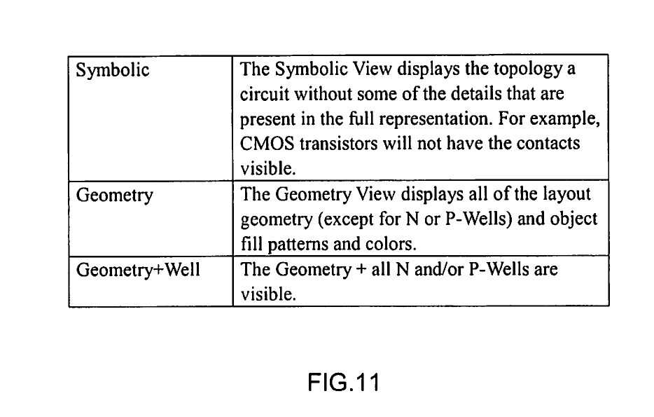

There are three viewing modes within the GUFI System. A diagram of the viewing modes is shown in a chart on FIG. 11.

SYMBOLIC: The Symbolic View displays the topology a circuit without some of the details that are present in the full representation. For example, CMOS transistors will not have the contacts visible.

GEOMETRY: The Geometry View displays all of the layout geometry (except for N or P-wells) and object fill patterns and colors.

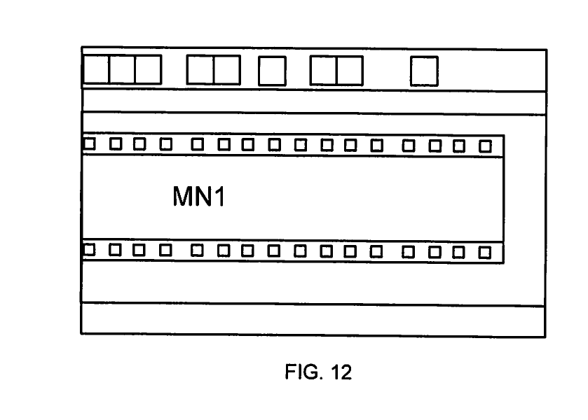

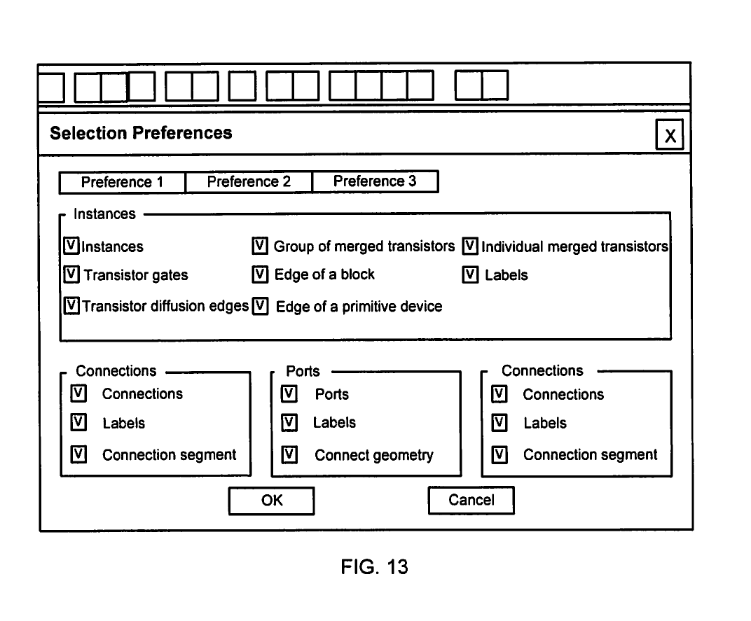

GEOMETRY+Well: The Geometry+Well shows all N and/or P-Wells. The ability to switch viewing modes from the keypad allows the user to quickly display or remove detail depending upon the task at hand. FIG. 12 shows the selection of the viewing mode from the toolbar, but it can also be selected from the keypad. Selection filters can be used when selection is difficult to use due to object congestion. FIG. 13 shows an example of a selection filter. Once configured, a user can swap between different selection filters through the keypad or by activating the appropriate selection preference tab.

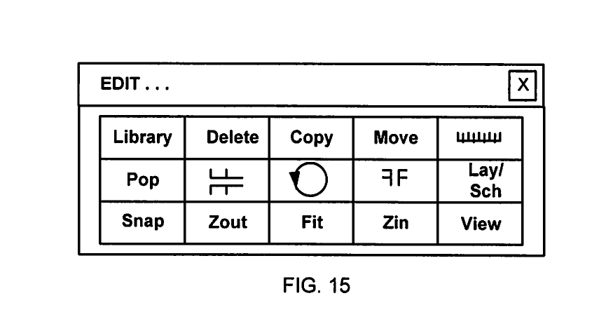

RULER: The user can measure distance by activating the Ruler. The user moves the cursor to the starting point of the measurement and activates the Ruler command from the Keypad. Other viewing commands like Fit, Zoom-in, Zoom-out and Pan are available while using the Ruler command. Use the mouse Escape to exit from the command. Activation of the Ruler can be through the Keypad as shown in FIG. 15.

Sometimes it may be useful to group particular items into a new sub-block. The group command will put all of the selection items into a new block at a deeper level of design hierarchy. The Group command may be useful in associating basic geometry objects so that they somewhat move and behave as a single unit. The Group command is accessible from the EDIT keypad when multiple items are selected.

### 4. Details of the Preferred Embodiment and Rule of GUFI in the Overall Layout Design Process

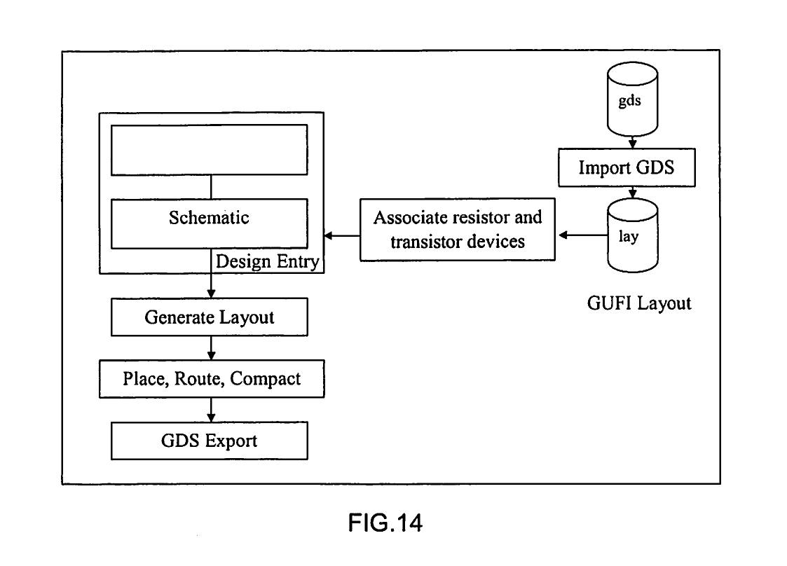

The Beta version of GUFI is a fully functional computer program that runs on the Windows NT operating system. GUFI allows the production of devices. A flowchart describing the steps involved in designing an electrical system is shown in FIG. 14.

GUFI supports device generation of transistors and resistors. The current version of GUFI supports one type of PMOS and one type of NMOS transistors and 4 different types of resistors. More resistors and transistors can easily be added. All supported devices are created automatically in the layout generation process based on the design rules entered in the technology file. These automatically generated devices can be further modified interactively without having to do polygon editing. Merging, unmerging, folding, unfolding, bending, unbending, stretching and un-stretching are supported for the MOS transistors.

Poly1 to Poly2 Capacitors are also supported and are automatically generated according to the design rules. Capacitor reshaping operations will maintain the initial area of the capacitor; however, additional layer (e.g. CDummy, EpiN) have to be applied to the device after the final capacitor shape has been determined.

GUFI allows simple and easy importation of files from the GDS format. Since the GDS device library has been generated, GUFI can convert the GDS files into the GUFI system and into the user's project with GUFI's GDS Import command. The command will automatically insert the necessary area connection ports to the appropriate cells. The area ports will define region in the cell where external connections can be made. Once the cell has been imported into the CADexterity GUFI System, the cells can be instantiated in the generated layout.

Design entry can be accomplished through the GUFI Schematic Design Editor or the Import operation. When a Spice net list is imported into the GUFI system, a schematic and/or a layout representation can be automatically generated FIG. 15.

Thus, the preferred embodiment of the present invention is a complete CAD layout package, which has been beta tested internally by engineers at CADexterity. Layout engineers can use the UFO Beta version to design physical integrated circuits.

### CONCLUSION

The philosophy of the above-described GUFI system can be used in many other drawing and design programs. GUFI is the first CAD layout design program to contextually execute command such as allowing a user to create a pin by double clicking at the terminating end of a path.

Although specific embodiments of the invention have been disclosed, it will be understood by those having skill in the art that minor changes can be made to the form and details of the specific embodiments disclosed herein, without departing from the scope of the invention. The embodiments presented above are for purposes of example only and are not to be taken to limit the scope of the appended claims.

What is claimed is:

1. A Graphical User Friendly Interface (GUFI) keypad system for a CAD computer program, comprising:
a menu in a CAD program, display in a computer screen;
a matrix held inside the menu, said matrix also displayed on said computer screen;
a plurality of buttons arranged in said matrix, forming a button matrix displayed on said computer screen;
a plurality of keyboard keys mapped to said plurality of buttons, whereby allowing a user to press one or more keyboard keys, whereby said pressed keyboard key presses its corresponding button activates corresponding CAD functions.

2. A GUFI keypad system as recited in claim 1, further comprising:
a refreshing means to contextually update the button matrix to a new context sensitive user definable button matrix;
a means for a user to manually navigate among a plurality of button matrices.

3. A GUFI keypad system as recited in claim 2, further comprising:
a pointing device such as a mouse or trackball that allows the user to configure the buttons on the button matrix whereby button can be added, moved or deleted.

4. A GUFI keypad system as recited in claim 2, wherein said means for a user to manually navigate among a plurality of button matrices includes pressing a button on a keyboard to cycle through contextually available button matrices.

5. A GUFI keypad system as recited in claim 4, further comprising:
a pointing device such as a mouse or trackball that allows the user to configure the button on the button matrix whereby buttons can be added, moved or deleted.

6. A GUFI keypad system as recited in claim 1, wherein said keyboard keys are mapped to said plurality of buttons according to a three by five matrix which is three high and five wide.

7. A GUFI keypad system as recited in claim 6, wherein said three by five matrix consists of:
keys Q W E R T mapped to a top row of said three by five matrix;
keys A S D F G mapped to a middle row of said three by five matrix;
keys Z X CV B mapped to a bottom row of said three by five matrix.

8. A GUFI keypad system as recited in claim 6, wherein said three by five matrix consists of:
keys Y U I O P mapped to a top row of said three by five matrix;
keys H J K L mapped to a middle row of said three by five matrix;
keys N M , . / mapped to a bottom row of said three by five matrix.

9. A GUFI keypad system as recited in claim 6, wherein said three by five matrix is configured to further display functionality of a button, when a user clicks on said button while pressing a predefined key.
